(19) United States
(12) Patent Application Publication
(10) Pub. No.: US 2024/0072965 A1
(43) Pub. Date: Feb. 29, 2024

(54) METHODS AND NODES FOR PUSCH PORT SELECTION FOR SRS TRANSMISSION WITH MULTIPLE SRS RESOURCE SETS

(71) Applicant: TELEFONAKTIEBOLAGET LM ERICSSON (PUBL), Stockholm (SE)

(72) Inventors: Mattias FRENNE, UPPSALA (SE); Sven JACOBSSON, VÄSTRA FRÖLUNDA (SE); Eleftherios KARIPIDIS, STOCKHOLM (US); Andreas NILSSON, GÖTEBORG (SE)

(21) Appl. No.: 18/261,470

(22) PCT Filed: Jan. 18, 2022
(86) PCT No.: PCT/IB2022/050400

§ 371 Date: Jul. 13, 2023

Related U.S. Application Data
(60) Provisional application No. 63/138,673, filed on Jan. 18, 2021.

(51) Int. Cl. H04L 5/00; H04W 72/232

(52) U.S. Cl. CPC H04L 5/0051; H04W 72/232; H04B 7/0456

(57) ABSTRACT

There is provided a method in a wireless device for uplink transmissions associated with a plurality of reference signal (RS) resources that belong to a plurality of resource sets. The method comprises: receiving downlink control information (DCI) indicating an uplink transmission, the DCI further comprising an indication of one or more RS resources from the plurality of RS resources, the one or more RS resources belonging to the plurality of resource sets; and performing the uplink transmission based on the indication of the one or RS resources in the DCI.

### RELATED APPLICATIONS

This application claims the benefits of priority of U.S. Provisional Patent Application No. 63/138,673, entitled “Methods and nodes for PUSCH port selection for SRS transmission with multiple SRS resource sets” and filed at the United States Patent and Trademark Office on Jan. 18, 2021, the content of which is incorporated herein by reference.

### TECHNICAL FIELD

The present description generally relates to wireless communication systems, and particularly, to methods and nodes related to PUSCH port selection for SRS transmissions with multiple SRS resource sets.

### BACKGROUND

The sounding reference signal (SRS) is used in third generation partnership project (3GPP) systems Long Term Evolution (LTE) and New Radio (NR) to estimate the channel in the uplink (UL). The application for the SRS is mainly to provide a reference signal to evaluate the channel quality in order to, e.g., derive the appropriate transmission/reception beams or to perform link adaptation (i.e., setting the rank, the modulation and coding scheme (MCS), and the multiple-input multiple-output (MIMO) precoder) for physical uplink shared channel (PUSCH) transmissions. The signal is functionality-wise similar to the downlink (DL) channel-state information reference signal (CSI-RS), which provides similar beam management and link adaptation functions in the DL. SRS can be used instead of (or in combination with) CSI-RS to acquire DL CSI (by means of uplink-downlink channel reciprocity) for enabling physical downlink shared channel (PDSCH) link adaptation.

In LTE and NR, the SRS is configured via radio resource control (RRC) and some parts of the configuration can be updated (for reduced latency) by medium access control (MAC) control element (CE) signaling. The configuration includes the SRS resource allocation (the physical mapping and sequence to use) as well as the time (aperiodic/semi-persistent/periodic) behavior. For aperiodic SRS transmission, the RRC configuration does not activate an SRS transmission from the user equipment (UE), but instead a dynamic activation trigger is transmitted via the physical downlink control channel (PDCCH)'s downlink control information (DCI) in the DL from the gNodeB (gNB) to order the UE to transmit the SRS once, at a predetermined time.

SRS Configuration

The SRS configuration allows generating an SRS transmission pattern based on an SRS resource configuration grouped into SRS resource sets. Each SRS resource is configured in RRC according to 3GPP 38.331 version 16.1.0.

To create the SRS resource on the time-frequency grid with the current RRC configuration, each SRS resource is thus configurable with respect to:

The transmission comb (i.e., mapping to every n^{th} subcarrier, where n=2 or n=4), configured by the RRC parameter transmissionComb.
For each SRS resource, a comb offset, configured by the RRC parameter combOffset, is specified (i.e., which of the n combs to use).
A cyclic shift, configured by the RRC parameter cyclicShift, that maps the SRS sequence to the assigned comb, is also specified. The cyclic shift increases the number of SRS resources that can be mapped to a comb, but there is a limit on how many cyclic shifts that can be used that depends on the transmission comb being used.
The time-domain position of an SRS resource within a given slot is configured with the RRC parameter resourceMapping.
A time-domain start position for the SRS resource, which is limited to be one of the last 6 symbols in a slot, is configured by the RRC parameter startPosition.
A number of orthogonal frequency-division multiplexing (OFDM) symbols for the SRS resource (that can be set to 1, 2 or 4) is configured by the RRC parameter nrolSymbols.
A repetition factor (that can be set to 1, 2 or 4) configured by the RRC parameter repetitionFactor. When this parameter is larger than 1, the same frequency resources are used multiple times across OFDM symbols, used to improve the coverage as more energy is collected by the receiver. It can also be used for beam-management functionality, where the gNB can probe different receive beams for each repetition.
The frequency-domain sounding bandwidth and position of an SRS resource in a given OFDM symbol (i.e., which part of the system bandwidth is occupied by the SRS resource) is configured with the RRC parameters freqDomainPosition, freqDomainShift and the freqHopping parameters: c-SRS, b-SRS and b-hop. The smallest possible sounding bandwidth in a given OFDM symbol is 4 resource blocks (RBs).

A schematic description of how an SRS resource is allocated in time and frequency in a given OFDM symbol within a slot is provided. Note that c-SRS controls the maximum sounding bandwidth, which can be smaller than the maximum transmission bandwidth the UE supports. For example, the UE may have capability to transmit over 40 MHz bandwidth, but c-SRS is set to a smaller value corresponding to 5 MHz, thereby focusing the available transmit power to a narrowband transmission which improves the SRS coverage.

In NR release 16, an additional RRC parameter called resourceMapping-r16 was introduced. If resourceMapping-r16 is signaled, the UE shall ignore the RRC parameter resourceMapping. The difference between resourceMapping-r16 and resourceMapping is that the SRS resource (for which the number of OFDM symbols and repetition factor is still limited to 4) can start in any of the 14 OFDM symbols within a slot, configured by the RRC parameter startPosition-r16. FIG. 1 and FIG. 2 show the differences. FIG. 1 illustrates a schematic description of how an SRS resource is allocated in time and frequency within a slot if resourceMapping-r16 is not signaled. FIG. 2 illustrates a schematic description of how an SRS resource is allocated in time and frequency within a slot if resourceMapping-r16 is signaled.

The RRC parameter resourceType configures whether the resource is transmitted as periodic, aperiodic (single transmission triggered by DCI), or semi persistent (same as periodic but the start and stop of the periodic transmission is controlled by MAC CE signaling instead of RRC signaling). The RRC parameter sequenceId specifies how the SRS sequence is initialized and the RRC parameter spatialRelationInfo configures the spatial relation for the SRS beam with respect to a reference signal (RS) which can be either another SRS, synchronization signal block (SSB) or CSI-RS. Hence, if the SRS has a spatial relation to another SRS, then this SRS should be transmitted with the same beam (i.e., spatial transmit filter) as the indicated SRS.

The SRS resource is configured as part of an SRS resource set. Within a set, the following parameters (common to all resources in the set) are configured in RRC:
The associated CSI-RS resource (this configuration is only applicable for non-codebook-based UL transmission) for each of the possible resource types (aperiodic, periodic and semi persistent). For aperiodic SRS, the associated CSI-RS resource is set by the RRC parameter csi-RS. For periodic and semi-persistent SRS, the associated CSI-RS resource is set by the RRC parameter associatedCSI-RS. Note that all resources in a resource set must share the same resource type.
For aperiodic resources, the slot offset is configured by the RRC parameter slotOffset and sets the delay from the PDCCH trigger reception to start of the transmission of the SRS resources measured in slots.
The resource usage, which is configured by the RRC parameter usage sets the constraints and assumption on the resource properties (see 3GPP 38.214).
The power-control RRC parameters alpha, p0, pathlossReferenceRS (indicating the downlink reference signal (RS) that can be used for path-loss estimation), srs-Pow erControlAdjustmentStates, and pathlossReferenceRSList-r16 (for NR release 16), which are used for determining the SRS transmit power.

Each SRS resource set is configured in RRC (see 3GPP 38.331 version 16.1.0 for an example).

Hence, it can be seen that in terms of resource allocation, the SRS resource set configures usage, power control, aperiodic transmission timing, and DL resource association. The SRS resource configuration controls the time-and-frequency allocation, the periodicity and offset of each resource, the sequence ID for each resource and the spatial-relation information.

Resource Mapping to Antenna Ports

SRS resources can be configured with four different usages: ‘beamManagement’, ‘codebook’, ‘nonCodebook’ or ‘antennaSwitching’.

SRS resources in an SRS resource set configured with usage ‘beamManagement’ are mainly applicable for frequency bands above 6 GHz (i.e., for frequency range 2 (FR2)) and the purpose is to allow the UE to evaluate different UE transmit beams for wideband (e.g. analog) beamforming arrays. The UE will then transmit one SRS resource per wideband beam, and the gNB will perform reference signal received power (RSRP) measurement on each of the transmitted SRS resources and in this way determine a suitable UE transmit beam. The gNB can then inform the UE which transmit beam to use by updating the spatial relation for different UL RSs. It is expected that the gNB will configure the UE with one SRS resource set with usage ‘beamManagement’ for each analog array (panel) that the UE has.

SRS resources in an SRS resource set configured with usage ‘codebook’ are used to sound the different UE antennas and let the gNB determine suitable precoders, rank and MCS for PUSCH transmissions. How each SRS port is mapped to each UE antenna is up to UE implementation, but it is expected that one SRS port will be transmitted per UE antenna, i.e. the SRS port to antenna-port mapping will be an identity matrix.

SRS resources in an SRS resource set configured with usage ‘nonCodebook’ are used to sound different potential precoders, autonomously determined by the UE. The UE determines a set of precoder candidates based on reciprocity, transmits one SRS resource per candidate precoder, and the gNB can then, by indicating a subset of these SRS resources, select which precoder(s) the UE should use for PUSCH transmissions. One UL layer will be transmitted per indicated SRS, hence candidate precoder. How the UE maps the SRS resources to the antenna ports is up to UE implementation and depends on the channel realization.

SRS resources in an SRS resource set configured with usage ‘antennaSwitching’ are used to sound the channel in the UL so that the gNB can use reciprocity to determine suitable DL precoders. If the UE has the same number of transmit and receive chains, the UE is expected to transmit one SRS port per UE antenna. The mapping from SRS ports to antenna ports is, however, up to the UE to decide and is transparent to the gNB.

SRS Coverage

Uplink coverage for SRS is identified as a bottleneck for NR and a limiting factor for DL reciprocity-based operation. Some measures to improve the coverage of SRS have been adopted in NR, for example repetition of an SRS resource and/or frequency hopping. One example of frequency hopping is illustrated in FIG. 3, where different parts of the frequency band is sounded in different OFDM symbols, which means that the power spectral density (PSD) for the SRS will improve. The illustrated frequency-hopping pattern in FIG. 3 is set according to Section 6.4 of 3GPP 38.211. FIG. 4 illustrates an example of repetition, where one SRS resource is transmitted in four consecutive OFDM symbols, which will increase the processing gain of the SRS.

SRS Power Scaling

SRS has its own UL power control (PC) scheme in NR, which can be found in Section 7.3 of 3GPP 38.213. Section 7.3 in 3GPP 38.213 additionally specifies how the UE should split the above output power between two or more SRS ports during one SRS transmit occasion (an SRS transmit occasion is a time window within a slot where SRS transmission is performed). Specifically, the UE splits the transmit power equally across the configured antenna ports for SRS.

SRS Antenna Switching

Since it is desirable for the gNB to sound all UE antennas (where sounding an antenna means transmitting an SRS from that antenna, which, in turn, enables the gNB to estimate the channel between the UE antenna and the antennas at the gNB) but costly to equip the UE with many transmit ports, SRS antenna switching was introduced in NR Rel-15, for several different UE architectures for which the number of receive chains is larger than the number of transmit chains. If a UE support antenna switching, it will report so by means of UE-capability signaling.

The left column of Table 1 (from 3GPP 38.306) lists SRS antenna-switching capabilities that can be reported from a UE in NR Rel-15. For example, if a UE reports t1r2 in the UE-capability signaling, it means that it has two receive antennas (i.e., two receive chains) but only has the possibility of transmitting from one of those antennas at a time (i.e., one transmission chain) with support for antenna switching. In this case, two single-port SRS resources can be configured to the UE such that it can sound both receive ports using a single transmit port with an antenna switch in between.

TABLE 1
SRS antenna-switching capabilities supported by the UE

| | supportedSRS-TxPortSwitch- |
|---|---|
| supportedSRS-TxPortSwitch | v1610 |
| t1r2 | t1r1-t1r2 |
| t1r4 | t1r1-t1r2-t1r4 |
| t2r4 | t1r1-t1r2-t2r2-t2r4 |
| t2r2 | t1r1-t2r2 |
| t4r4 | t1r1-t2r2-t4r4 |
| t1r4-t2r4 | t1r1-t1r2-t2r2-t1r4-t2r4 |

Additional UE capabilities were further introduced in NR Rel-16, see the right column of Table 1, which indicates support for the UE to be configured with SRS resource set(s) with usage ‘antennaSwitching’ but where only a subset of all UE antennas is sounded. For example, the UE capability t1r1-t1r2 means that the gNB can configure one single-port SRS resource (same as no antenna-switching capability) or two single-port SRS resources (same as for the capability “t1r2” described above) with usage ‘antennaSwitching’ per SRS resource set. In this case, if the UE is configured with a single SRS resource (no antenna switching), it will sound only one of its two antennas, which will save UE power consumption at the cost of reduced channel knowledge at the gNB (since the gNB can only estimate the channel between itself and the UE based on one of the two UE antennas).

Each entry in Table 1 is referred to as an “Antenna switching configuration” (ASC). Each ASC is associated with one or several possible SRS configurations (where each SRS configuration typically includes a number of SRS resource sets, a number of SRS resources per SRS resource set, a number of SRS ports per SRS resource, etc.). Hence, if a UE signals the UE capability t1r1-t1r2, it means that the UE supports to be configured both with the ASC t1r1 and the ASC t1r2.

### SUMMARY

A UE that is configured to support reciprocity-based operation (i.e. SRS configured with usage ‘antennaSwitching’) and codebook-based Uplink (UL) transmission (i.e. SRS configured with usage ‘codebook’), needs to be configured with SRS for both cases, which is a waste of resources. A solution describing how to combine SRS with usage ‘antennaSwitching’ and ‘codebook’ has been disclosed, including a further enhancement for PUSCH including signaling which UE antennas to transmit the PUSCH from (e.g. for 1T4R antenna switching, the gNB gets knowledge of which UE antenna that has the best channel conditions and, hence, could signal the UE to use this antenna for future PUSCH transmissions).

However, this solution only applies to the case when antenna switching is performed using a single SRS resource set. It does not consider the case where the transmitted SRS resources belong to multiple different SRS resource sets, which, for example would be the case for aperiodic SRS transmission with usage ‘antennaSwitching’ for 1T4R, which in NR Rel-16 requires two SRS resource sets being transmitted in two different slots. In NR Rel-17, it is expected that antenna switching will be extended to UE architectures with 6 and 8 receive antennas. In such architectures, it becomes increasingly likely that multiple SRS resource sets will be used for antenna switching.

In NR Rel-16, a UE can be configured with at most one SRS resource set configured with usage ‘codebook’ (which, in turn, can contain up to two SRS resources (unless fullpowerMode2 is signaled)). Hence, how to combine SRS with joint usage for ‘codebook’ and ‘antennaSwitching’ for cases with multiple SRS resource sets is a problem.

This disclosure provides a solution that enables the SRS configured for antenna switching (which is originally intended for reciprocity-based operation) to be used also for codebook-based UL PUSCH (or PUCCH) transmissions.

The solution covers cases when SRS antenna switching is performed over multiple slots (i.e., using multiple SRS resource sets), which is required, for example, for common NR UEs equipped with 1 transmit (TX) antenna and 4 Receive (RX) antennas.

For example, an SRS configuration containing one or more SRS resource sets (with one or more SRS resources in each SRS resource set) used for mTnR antenna switching (i.e., for reciprocity-based DL transmission) is used also for codebook-based UL transmission in order to reduce SRS overhead (in terms of transmissions and signaling).

There is also provided a signaling framework for indicating SRS resources (used for scheduling PUSCH) contained within a plurality of SRS resource sets, through the SRS request indicator (SRI) field in the DCI, which allows more flexible SRS configurations and improves performance for codebook-based UL transmissions for various antenna-switching architectures (as more UE antennas can be sounded for codebook design).

According to a first aspect, some embodiments include methods performed by a wireless device. For example, a method may comprise: receiving downlink control information (DCI) indicating an uplink transmission, the DCI further comprising an indication of one or more RS resources from the plurality of RS resources, the one or more RS resources selected from the plurality of resource sets; and performing the uplink transmission based on the indication of the one or more RS resources in the DCI.

According to a second aspect, some embodiments include a wireless device configured, or operable, to perform one or more functionalities (e.g. actions, operations, steps, etc.) as described herein.

According to a third aspect, some embodiments include methods performed by a network node. For example, a method may comprise: sending downlink control information (DCI) indicating an uplink transmission, the DCI further comprising an indication of one or more RS resources from the plurality of RS resources, the one or more RS resources selected from the plurality of resource sets; and receiving the uplink transmission based on the indication of the one or more RS resources in the DCI.

According to a fourth aspect, some embodiments include a network node configured, or operable, to perform one or more functionalities (e.g. actions, operations, steps, etc.) as described herein.

In some embodiments, the wireless device and network node may comprise one or more communication interfaces configured to communicate with one or more other radio nodes and/or with one or more network nodes, and processing circuitry operatively connected to the communication interface, the processing circuitry being configured to perform one or more functionalities as described herein. In some embodiments, the processing circuitry may comprise at least one processor and at least one memory storing instructions which, upon being executed by the processor, configure the at least one processor to perform one or more functionalities as described herein.

According to yet another aspect, some embodiments include a non-transitory computer-readable medium storing a computer program product comprising instructions which, upon being executed by processing circuitry (e.g., at least one processor) of the network node or wireless device, configure the processing circuitry to perform one or more functionalities as described herein.

The benefit of the embodiments of the present disclosure is that overhead (in terms of SRS transmissions and SRS RRC signaling) is reduced, compared to existing releases of NR, since a single SRS configuration can be used for both reciprocity-based DL operation and for codebook-based UL operation. This improves on existing releases of NR for which two separate configurations were needed.

Another advantage is that antenna selection is introduced for PUSCH. Hence, based on the measurements from the antenna switching over all the UEs antennas, a gNB can choose which antenna(s) to be used for PUSCH and can thereby optimize the uplink performance. This is useful if, for example, a user is blocking one or more of the UE antennas with e.g. his/her hand.

This summary is not an extensive overview of all contemplated embodiments and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

Exemplary embodiments will be described in more detail with reference to the following figures, in which:

FIG. 1 illustrates a schematic description of how an SRS resource is allocated in time and frequency within a slot if resourceMapping-r16 is not signaled.

FIG. 2 illustrates a schematic description of how an SRS resource is allocated in time and frequency within a slot if resourceMapping-r16 is signaled.

FIG. 3 illustrates an exemplary SRS transmission using frequency hopping.

FIG. 4 illustrates an exemplary SRS transmission using repetition.

FIG. 5 illustrates an example of a signaling diagram between a wireless device and a network node for a SRS transmission for reciprocity-based DL transmission and codebook-based UL transmission (with usage set to “antennaSwitchingAndCodebook’).

FIG. 6 illustrates a schematic diagram of a SRS resource set configured for usage ‘antennaSwitching’ (supported in NR Rel-16), ‘codebook’ (not supported in NR Rel-16, but supported by the presented disclosure), or ‘antennaSwitchingAndCodebook’ (new use case supported by the presented disclosure).

FIG. 7 is a flow chart of a method in a wireless device, in accordance with an embodiment.

FIG. 8 is a flow chart of a method in a network node, in accordance with an embodiment.

FIG. 9 illustrates one example of a wireless communications system in which embodiments of the present disclosure may be implemented.

FIG. 10 is a block diagram that illustrates a wireless device according to some embodiments of the present disclosure.

FIG. 11 is a block diagram that illustrates a network node according to some embodiments of the present disclosure

FIG. 12 illustrates a virtualized environment of a network node, according to some embodiments of the present disclosure.

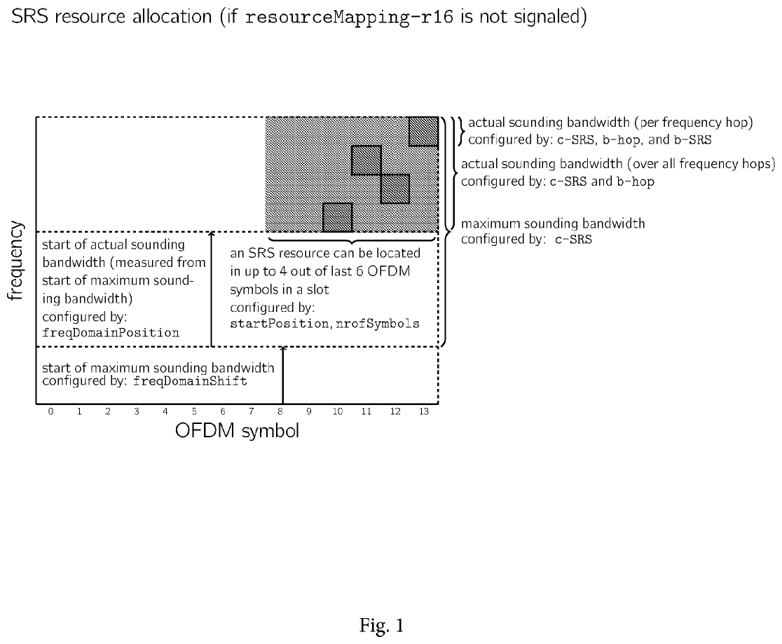

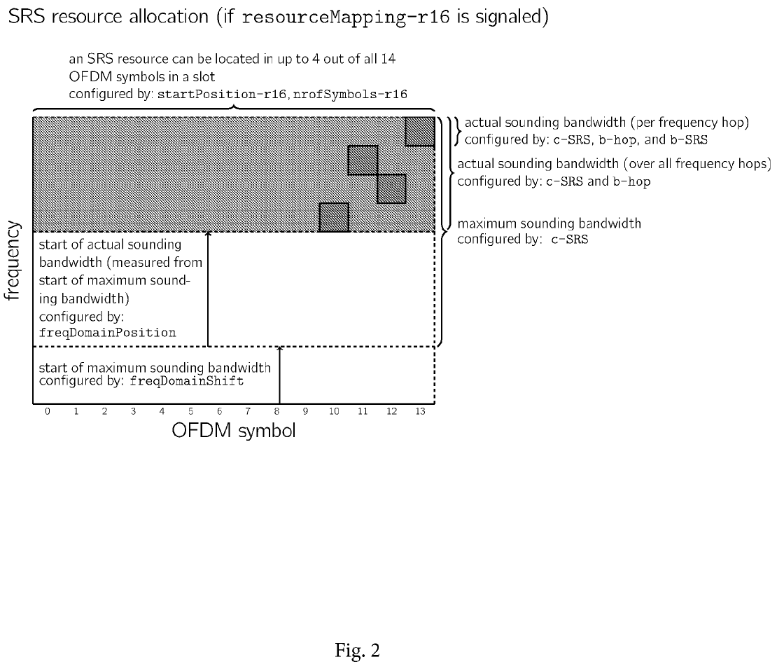

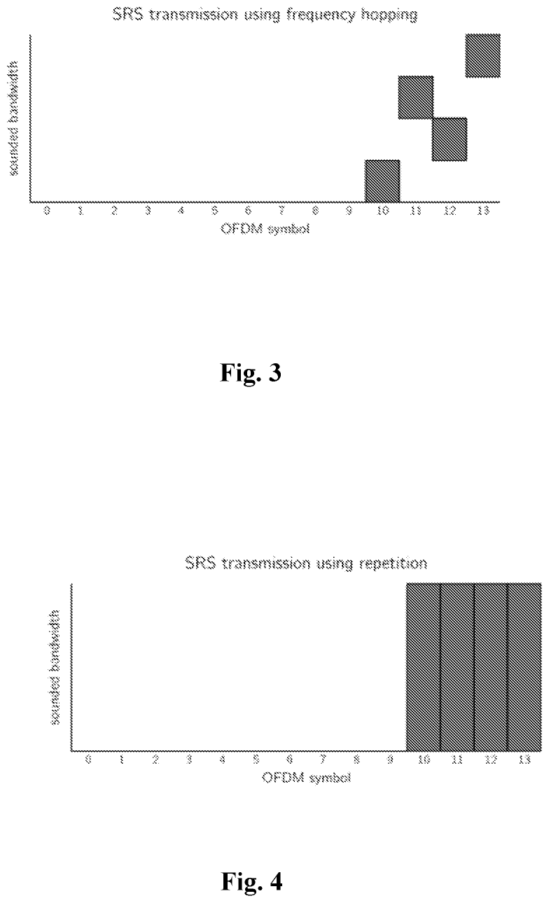

### DETAILED DESCRIPTION

The embodiments set forth below represent information to enable those skilled in the art to practice the embodiments. Upon reading the following description in light of the accompanying figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the singular forms “a”, “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

In this disclosure, the notation t1r2 or 1t2r denotes a capability of the UE, for antenna switching, for example. In contrast, the notation TmRn or mTnR is used to denote a configuration. For example, 1T4R antenna switching may be configured only if the UE has reported antenna-switching capability that includes, at least, t1r4.

One reason behind the aforementioned problem is that the SRS resource indicator (SRI) field in the DCI format 0_1 or 0_2 used to indicate which antenna ports to use for the granted codebook-based PUSCH transmission, points to one (or several) SRS resource(s) belonging to a single SRS resource set.

Embodiments in this disclosure enable the SRI to point to SRS resources in a single or multiple SRS resource sets (potentially spanning across multiple slots since the slot offset is configured per set). This provides an indication of which SRS resources to be used (associated) with a granted PUSCH transmission where SRS resources to “choose from” can be transmitted in different slots (in legacy operation, only SRS transmitted in the same slot can be chosen from). The SRS resources could possibly be used for ‘antennaSwitching’ as well as for ‘codebook’.

In this disclosure, it is assumed that the relevant SRS resources belong to one or many sets with usage ‘codebook’ or with a newly defined usage that indicates joint antenna-switching and codebook use. In what follows, this new use case is referred to as ‘antennaSwitchingAndCodebook’.

If the SRS is configured with usage ‘antennaSwitchingAndCodebook’, the gNB uses the measured SRS to estimate the DL channel for reciprocity-based DL transmission, and also uses the measured SRS to determine which subset of the SRS resources to be associated with an UL PUSCH transmission (together with assigning a precoder to use for that PUSCH transmission from a codebook of precoders).

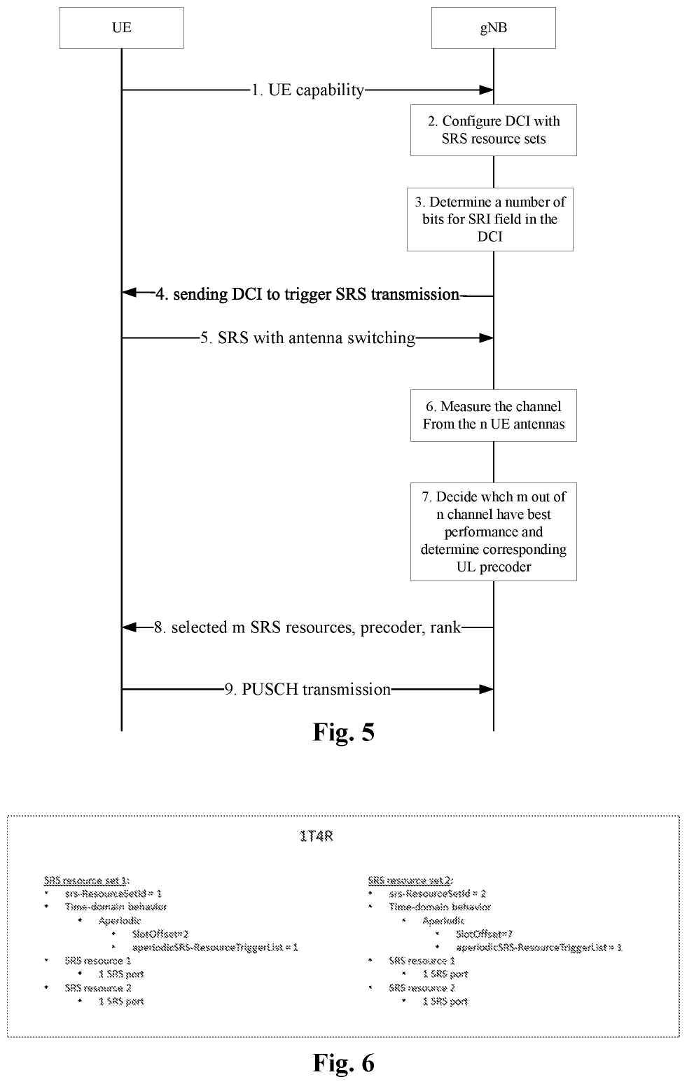

The steps taken for an aperiodic SRS transmission for ‘antennaSwitchingAndCodebook’ followed by an UL PUSCH transmission are as follows (and are illustrated in FIG. 5):
Step 1: the UE reports UE capability, related to antenna switching, e.g. mTnR, (m n) and related to UL codebook based operation, to the gNB (or the gNB obtains this information about the UE in handover information from a neighboring cell).
Step 2: the gNB configures a plurality of UE SRS resource sets (containing SRS resources) with usage “antennaSwitchingAndcodebook” for an aperiodic SRS trigger code point in DCI.
Step 3: Depending on the configured antenna-switching scheme, the number of SRI bits in DCI 0_1 and/or 0_2 is determined (┌log₂ n/m┐ bits) and is thereby known to the gNB and to the UE.
Step 4: the gNB triggers aperiodic SRS transmission of the configured sets using DCI.
Step 5: the UE transmits SRS according to the indicated SRS trigger codepoint in DCI and perform the mTnR, (m≤n) antenna switching scheme accordingly.
Step 6: the gNB measures the channel from the n UE antennas.
Step 7: the gNB decides which m out of the n channels have best predicted performance for PUSCH transmission over m ports and the eventual UL precoder to be used for this transmission.
Step 8: the gNB schedules a PUSCH transmission by signaling to the UE the selected subset of m SRS resources from the n transmitted SRS resources using the SRI field in the DCI, together with other PUSCH parameters, such as the precoder and rank to be used for the m-port PUSCH transmission.
Step 9: the UE transmits PUSCH using the indicated m ports which are the same m ports that the UE used to transmit the corresponding SRS resources in Step 5.

It is assumed here that the SRS transmission can consist of one or several SRS resource sets. This disclosure describes details regarding how the gNB indicates to the UE which of the sounded UE antennas (i.e. SRS resources) to use for PUSCH transmissions from one or multiple SRS resource sets.

FIG. 6 shows one SRS configuration used to illustrate a first embodiment for a 1T4R UE configured for aperiodic SRS transmission used for UL codebook-based precoding. Both SRS resource sets consist of two single-port SRS resources (“SRS resource 1” and “SRS resource 2”) that are configured to adhere to the antenna-switching procedure detailed in Clause 6.2.1.2 of 3GPP TS 38.214 (for example, the SRS resources in the set must be transmitted in different OFDM symbols and with a guard symbol in between). The only thing that differs between the two SRS resource sets is the value of the “srs-ResourceSetId” and the “slotOffset” fields in the SRS config. Information Element (IE) (see 3GPP TS 38.311). Since different slotOffsets are configured, these sets are transmitted in different slots, which is a benefit of using multiple sets (as all resources of a set is constrained to be transmitted within the same slot).

Assume that the UE has been triggered with the SRS transmission for the 1T4R configuration described in FIG. 6, and the gNB would like to indicate to the UE which of the n=4 UE antennas (i.e. the four SRS resources) that should be used for single-layer PUSCH transmission.

Since, in current releases of NR (Rel-15/16), the SRI field in DCI format 0_1 and 0_2 can only be used for selecting one SRS resource within a single SRS resource set, and since two different SRS resource sets are used here, it is not obvious for the UE which SRS resource set the SRI will be pointing to, and hence the UE will not know which UE antenna (SRS port) to use for upcoming PUSCH transmissions. In the example above, there are in total n=4 SRS resources spread over two sets but only 2 can be selected using 1 bit SRI. It is unclear which SRS resource the SRI bit indicates.

Embodiments of this disclosure allow the SRI to point out m SRS resources of n possible SRS resources, where the n resources belong to one or more SRS resource sets. Several methods will be described hereinbelow.

In a first embodiment, a single SRI field is used, which indicates both the SRS resource set and the SRS resource.

In one example, there is an implicit rule that associates the SRI codepoints and the SRS resources over the multiple SRS resource sets. One example could be that the SRS resources are implicitly listed according to a certain order and the codepoint with smallest number is pointing to the first SRS resource in that order, the second smallest codepoint points to the second SRS resource according to that order, and so on.

In another example, the SRS resources are ordered according to the following: first consider the SRS resources in the SRS resource set with the lowest SRS resource set ID (i.e. with lowest value of “srs-ResourceSetId” as specified in 3GPP TS 38.331), and order SRS resources within each SRS resource set in an ascending order according to their SRS resource ID (i.e. according to the value of srs-ResourceId as specified in 3GPP TS 38.331). Then proceed to the SRS resource set with the second lowest SRS resource set ID, and so on.

For example, assume that a 1T4R UE is configured with four SRS resources belonging to the two SRS resource sets as shown in FIG. 6. In this case, the mapping between the SRI codepoints and the SRS resources could be as listed in Table 2. In this example, the most significant bit (MSB) of the SRI codepoint indicates the set ID and the least significant bit (LSB) indicates the resource ID. However, this may not be generally be the case, for example if the different sets do not contain the same number of resources or if the SRS resources are spread out over more than two SRS resource sets.

TABLE 2
Example where the MSB of a SRI codepoint indicates the set ID
and the LSB indicates the resource ID for the case when there
are two SRS resource sets with two SRS resources in each.

| SRI codepoint | SRS set ID | SRS resource ID |
|---|---|---|
| 00 | 1 | 1 |
| 01 | 1 | 2 |
| 10 | 2 | 1 |
| 11 | 2 | 2 |

In another example, the order of the SRS resources within each SRS resource set is not based on the “srs-ResourceId”, but instead the order is on how the SRS resources are listed in the list “srs-ResourceIdList” as specified in 3GPP TS 38.331. So, for example, if the list “srs-ResourceIdList” for a certain SRS resource set is configured as [SRS resource ID 4; SRS resource ID 3], then the SRS resource ID 4 should be ordered before SRS resource ID 3 in the implicit sequential order of the SRS resource in that SRS resource set since it is listed first.

In another example, the size of the SRI field is related to the total number of SRS resources in all the associated SRS resource sets. For example, if two associated SRS resource sets are triggered, where each SRS resource set consist of two SRS resources (as in the example of FIG. 6), then a 2-bit SRI is needed (since there are four different possible indications (SRS resources) that can be indicated for a PUSCH transmission). The number of bits for SRI in DCI may be calculated as ┌log₂ n/m┐ bits if mTnR antenna switching is configured.

In another example, two separate bitfields can be configured in the DCI, where a first bitfield is used to indicate the SRS resource set, and the second bitfield is used to indicate the SRS resource within the indicated SRS resource set. The size of the first bitfield used to indicate the SRS resource set is related to the number of SRS resource sets used, and the size of the second bitfield is related to the largest number of SRS resources in any SRS resource set. For example, in case there are two SRS resource sets, and where each SRS resource set has two SRS resources, then the size of the first bitfield can be one bit, and the size of the second bitfield used for SRS resource indication inside the indicated SRS resource set can be one bit. This example can be applied to 1T4R and 2T8R antenna switching for which the four resources are sounded in two different sets (i.e., slots).

Generally stated, if there are X resource sets, the length of the first bitfield is log 2(X) bits and if there are Y resources in each set, the length of the second bitfield is log 2(Y).

Antenna switching configurations for 1T6R and 1T8R may be exceptional cases. For these cases, there are two ways to split the SRS resources into the SRS resources sets, as follows:
1) Assume that there are R (where R is 6 or 8) resources spread over R sets, in this case the size of the first bitfield is log 2(R) bits and the size of the second bitfield is 0 bits.
2) Assume that there are R (where R is 6 or 8) resources spread over 1 set, in this case the size of the first bitfield is 0 bits and the size of the second bitfield is log 2(R) bits.

In another example that essentially achieves the same as above, the SRS usage is set to “antennaSwitching” as in the previous NR releases (i.e. without introducing the new usage “antennaSwitchingAndcodebook”). So, the SRS transmission is unchanged. However, a higher layer signaling (or signaling in DCI that triggers the aperiodic or semi-persistent SRS) from the gNB to the UE indicates that the SRS transmission using the SRS resource will also be used for codebook-based transmission and will thus be referenced when scheduling PUSCH. The SRI field size in the DCI is set accordingly, by possible extensions to more bits compared to the legacy of 1 bit, and with the new interpretation elaborated above that allows to indicate a subset m of n≥m SRS resource(s) where the n SRS resources are allowed to span more than one SRS resource set.

### ADDITIONAL EXAMPLES

It has been agreed in 3GPP that for multi-transmission/reception point (multi-TRP) operation, a UE can have one SRS resource set with usage ‘codebook’ per TRP and it is proposed that two SRI fields then are included in the DCI format 0_1 and 0_2, where one SRI field indicates the SRS resource associated with one TRP and the other SRI field indicates the SRS resource for the second TRP. Note that embodiments herein are described for single TRP operation, however, the embodiments can easily be extended to multi-TRP operation, by duplicating the different parameters (i.e. one or multiple SRS resource sets can be configured per TRP, and the embodiments related to SRS resource indication can be duplicated such that is done per TRP).

Note that the above examples are described for aperiodic SRS transmissions, however they are equally applicable for periodic and semi-persistent SRS resources. Also, the embodiments above may be applicable to any reference signals, they are not limited to SRS.

As a further note, in some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may use multiple TCI states. In some embodiments, a TRP may be a part of the gNB transmitting and receiving radio signals to/from the UE according to physical layer properties and parameters inherent to the TRP. In some embodiments, in Multiple Transmit/Receive Point (multi-TRP) operation, a serving cell can schedule the UE from two TRPs, providing better PDSCH coverage, reliability and/or data rates. There are two different operation modes for multi-TRP: single-DCI and multi-DCI. For both modes, control of uplink and downlink operations is done by both physical layer and Medium Access Control (MAC). In single-DCI mode, the UE is scheduled by the same DCI for both TRPs and in multi-DCI mode, the UE is scheduled by independent DCIs from each TRP.

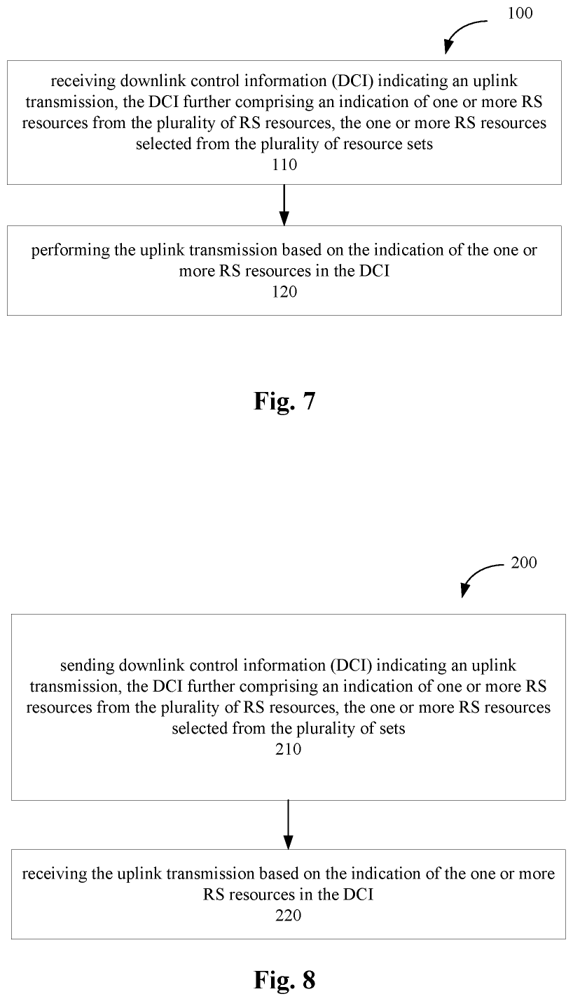

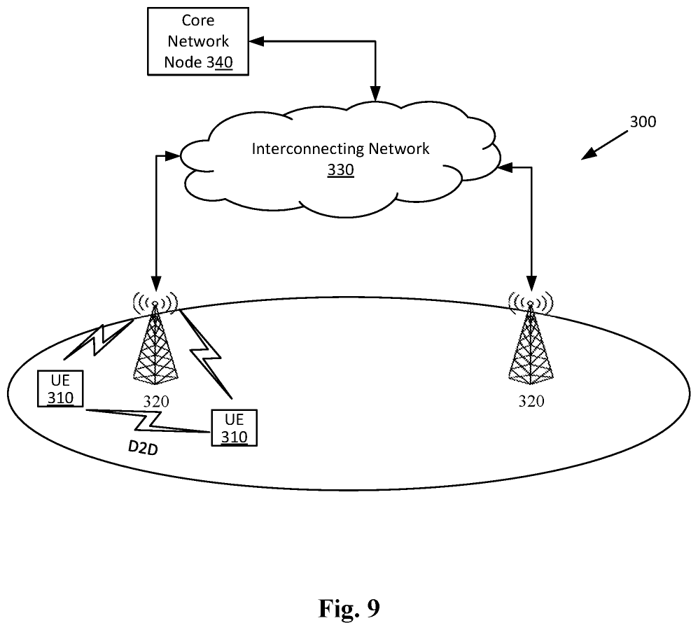

Now, turning to FIG. 7, a method 100 in a wireless device (or UE) for uplink transmissions (e.g. PUSCH or PUCCH) will be described. For example, the network node can request a RS or SRS transmission from the wireless device; the reference signals can be used for both reciprocity-based DL transmission and codebook-based UL based transmission, for example. Also, the resources for SRS or RS can belong to different SRS or RS resource sets. Once the network node receives the RSs from the wireless device, it can select/choose/determine the RS resources to use for uplink transmissions (see for example steps 6 and 7 of FIG. 5). Then, it can transmit the information to the wireless device. Method 100 can be implemented in a wireless device (such as 310 of FIG. 9) and comprises the following steps:
Step 110: receiving downlink control information (DCI) indicating an uplink transmission, the DCI further comprising an indication of one or more RS resources from the plurality of RS resources, the one or more RS resources selected from the plurality of resource sets; and
Step 120: performing the uplink transmission based on the indication of the one or more RS resources in the DCI.

In some examples, the RS can be a sounding RS and the one or more RS resources are SRS resources.

In some examples, the indication can be an implicit indication.

In some examples, the DCI can comprise a SRS Resource Indicator (SRI) field, which indicates both the SRS resources and the SRS resource sets to which the indicated one or more SRS resources belong.

In some examples, the plurality of RS resources can be listed according to a certain order and a plurality of codepoints of the SRI field can be associated with the list of ordered RS resources.

For example, the codepoints in the SRI field can be associated with a RS or SRS resource using an implicit rule, e.g. SRS resources are implicitly listed according to a certain order and the codepoint with smallest number is pointing to the first SRS resource in that order, the second smallest codepoint points to the second SRS resource according to that order, and so on.

In some examples, the resource sets can be ordered in an ascending order and the SRS resources can be ordered in an ascending order within each resource set. As such, the indication of the SRS resource and the resource set in which the SRS resource belongs to can be an implicit indication. Other implicit indications can be used as well.

In some examples, the most significant bit (MSB) of the codepoint can indicate an ID (identity/identifier) of the resource set and the least significant bit (LSB) can indicate an ID of the SRS or RS resource.

In some examples, the wireless device can be configured with 1 transmit chain and 4 receive chains (1T4R).

In some examples, the RS resources or SRS resources can be ordered based on a list of resources (e.g. srs-ResourceIdList).

In some examples, a size of the SRI field can be related to a total number of RS resources in the plurality of RS resources across the plurality of resource sets.

In some examples, the size of the SRI field is determined as ┌log₂ n/m┐ bits if mTnR antenna switching is configured.

In some examples, two separate bitfields can be configured in the DCI, a first bitfield for indicating a resource set and a second bitfield for indicating a RS resource within the resource set indicated by the first bitfield.

In some examples, the one or more RS resources indicated in the DCI can be used for reciprocity-based operation and codebook-based uplink transmission (e.g. usage is set to ‘antennaSwitchingAndcodebook’).

In some examples, a usage of the one or more RS resources indicated in the DCI is set to antenna switching.

In this case, the wireless device may receive a signaling indicating that the one or more RS resources indicated in the DCI can be also used for codebook-based transmissions. For example, the signaling may be DCI or higher layer (e.g. RRC).

In some examples, the DCI can be DCI format 0_1 or DCI format 0_2.

In some examples, the DCI may comprise two or more SRI fields, each SRI field associated with a Transmission/Reception Point (TRP), when the wireless device operates in a multi-TRP environment.

In some examples, a SRS (or RS) transmission can be an aperiodic SRS (or RS) transmission, a periodic SRS (or RS) transmission and a semi-persistent SRS (or RS) transmission.

In some examples, the DCI may further comprise precoding information for the uplink transmission and other parameters related to the uplink transmission.

In some examples, the SRI field may indicate one SRS resource per resource set up to two resource sets from the plurality of resource sets.

FIG. 8 illustrates a method 200 in a network node. For example, the network node can send a request for a RS or SRS transmission from the wireless device, the reference signals being used for both reciprocity-based DL transmission and codebook-based UL based transmission, for example. Also, the resources for SRS or RS can belong to different SRS or RS resource sets. Once the network node receives the RSs from the UE, it can select or choose/determine one or more RS resources for uplink transmissions (see for example steps 6 and 7 of FIG. 5). Then, it can indicate the one or more RS resources to the wireless device for uplink transmissions. Method 200 can be implemented in a network node such as 320 of FIG. 9, and comprises the following steps:

Step 210: sending downlink control information (DCI) indicating an uplink transmission, the DCI further comprising an indication of one or more RS resources from the plurality of RS resources, the one or more RS resources selected from the plurality of resource sets; and

Step 220: receiving the uplink transmission based on the indication of the one or more RS resources in the DCI.

In some examples, the RS can be a sounding RS and the one or more RS resources can be SRS resources.

In some examples, the indication can be an implicit indication.

In some examples, the DCI can comprise a SRS Resource Indicator (SRI) field, which indicates both the SRS resources and the SRS resource sets to which the indicated one or more SRS resources belong.

In some examples, the plurality of RS resources can be listed according to a certain order and a plurality of codepoints of the SRI field can be associated with the list of ordered RS resources.

For example, the codepoints in the SRI field can be associated with a SRS resource using an implicit rule, e.g. SRS resources are implicitly listed according to a certain order and the codepoint with smallest number is pointing to the first SRS resource in that order, the second smallest codepoint points to the second SRS resource according to that order, and so on.

In some examples, the resource sets can be ordered in an ascending order and the RS resources can be ordered in an ascending order within each resource set.

In some examples, the most significant bit (MSB) of the codepoint can indicate an ID (identity/identifier) of the resource set and the least significant bit (LSB) can indicate an ID of the RS resource.

In some examples, the wireless device can be configured with 1 transmit chain and 4 receive chains (1T4R).

In some examples, the RS resources or SRS resources can be ordered based on a list of resources (e.g. srs-ResourceIdList).

In some examples, a size of the SRI field can be related to a total number of RS resources in the plurality of RS resources across the plurality of resource sets.

In some examples, the size of the SRI field can be determined as ┌log₂ n/m┐ bits if mTnR antenna switching is configured.

In some examples, two separate bitfields can be configured in the DCI, a first bitfield for indicating a resource set and a second bitfield for indicating a RS resource within the resource set indicated by the first bitfield.

In some examples, the one or more RS resources indicated in the DCI can be used for reciprocity-based operation and codebook-based uplink transmission (e.g. usage is set to ‘antennaSwitchingAndcodebook’).

In some examples, a usage of the one or more RS resource indicated in the DCI can be set to antenna switching.

In this case, the network node may send a signaling indicating that the one or more RS resources indicated in the DCI can be also used for codebook-based transmissions. For example, the signaling can be DCI or higher layer (e.g. RRC).

In some examples, the DCI can be a DCI format 0_1 or DCI format 0_2.

In some examples, the DCI may comprise two or more SRI fields, each SRI field associated with a Transmission/Reception Point (TRP), when the wireless device operates in a multi-TRP environment.

In some examples, a SRS (or RS) transmission can be an aperiodic SRS (or RS) transmission, a periodic SRS (or RS) transmission and a semi-persistent SRS (or RS) transmission.

In some examples, the DCI further comprises precoding information for the uplink transmission and other parameters related to the uplink transmission.

In some examples, the SRI field can indicate one RS resource per resource set up to two resource sets from the plurality of resource sets.

FIG. 9 illustrates an example of a wireless network 300 that may be used for wireless communications. Wireless network 300 includes UEs 310 and a plurality of radio network nodes 320 (e.g., Node Bs (NBs) Radio Network Controllers (RNCs), evolved NBs (eNBs), next generation NB (gNBs), etc.) directly or indirectly connected to a core network 330 which may comprise various core network nodes. The network 300 may use any suitable radio access network (RAN) deployment scenarios, including Universal Mobile Telecommunication System (UMTS) Terrestrial Radio Access Network (UTRAN), and Evolved UMTS Terrestrial Radio Access Network (EUTRAN). UEs 310 may be capable of communicating directly with radio network nodes 320 over a wireless interface. In certain embodiments, UEs may also be capable of communicating with each other via device-to-device (D2D) communication. In certain embodiments, network nodes 320 may also be capable of communicating with each other, e.g. via an interface (e.g. X2 in LTE or other suitable interface).

As an example, UE 310 may communicate with radio network node 320 over a wireless interface. That is, UE 310 may transmit wireless signals to and/or receive wireless signals from radio network node 320. The wireless signals may contain voice traffic, data traffic, control signals, and/or any other suitable information. In some embodiments, an area of wireless signal coverage associated with a radio network node 320 may be referred to as a cell.

It should be noted that a UE may be a wireless device, a radio communication device, target device, device to device (D2D) UE, machine type UE or UE capable of machine to machine communication (M2M), a sensor equipped with UE, iPAD, Tablet, mobile terminals, smart phone, laptop embedded equipped (LEE), laptop mounted equipment (LME), Universal Serial Bus (USB) dongles, Customer Premises Equipment (CPE) etc.

In some embodiments, the “network node” can be any kind of network node which may comprise of a radio network node such as a radio access node (which can include a base station, radio base station, base transceiver station, base station controller, network controller, gNB, NR BS, evolved Node B (eNB), Node B, Multi-cell/multicast Coordination Entity (MCE), relay node, access point, radio access point, Remote Radio Unit (RRU), Remote Radio Head (RRH), a multi-standard BS (also known as MSR BS), etc.), a core network node (e.g., MME, SON node, a coordinating node, positioning node, MDT node, etc.), or even an external node (e.g., 3rd party node, a node external to the current network), etc. The network node may also comprise a test equipment.

In certain embodiments, network nodes 320 may interface with a radio network controller (not shown). The radio network controller may control network nodes 320 and may provide certain radio resource management functions, mobility management functions, and/or other suitable functions. In certain embodiments, the functions of the radio network controller may be included in the network node 320. The radio network controller may interface with the core network node 340. In certain embodiments, the radio network controller may interface with the core network node 340 via the interconnecting network 330.

The interconnecting network 330 may refer to any interconnecting system capable of transmitting audio, video, signals, data, messages, or any combination of the preceding. The interconnecting network 330 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the core network node 340 may manage the establishment of communication sessions and various other functionalities for wireless devices 310. Examples of core network node 340 may include MSC, MME, SGW, PGW, O&M, OSS, SON, positioning node (e.g. E-SMLC), MDT node, etc. Wireless devices 110 may exchange certain signals with the core network node 340 using the non-access stratum layer. In non-access stratum signaling, signals between wireless devices 310 and the core network node 340 may be transparently passed through the radio access network. In certain embodiments, network nodes 320 may interface with one or more other network nodes over an internode interface. For example, network nodes 320 may interface each other over an X2 interface.

Although FIG. 9 illustrates a particular arrangement of network 300, the present disclosure contemplates that the various embodiments described herein may be applied to a variety of networks having any suitable configuration. For example, network 300 may include any suitable number of wireless devices 310 and network nodes 320, as well as any additional elements suitable to support communication between wireless devices or between a wireless device and another communication device (such as a landline telephone). The embodiments may be implemented in any appropriate type of telecommunication system supporting any suitable communication standards and using any suitable components and are applicable to any radio access technology (RAT) or multi-RAT systems in which the wireless device receives and/or transmits signals (e.g., data). While certain embodiments are described for NR and/or LTE, the embodiments may be applicable to any RAT, such as UTRA, E-UTRA, narrow band internet of things (NB-IoT), WiFi, Bluetooth, next generation RAT (NR, NX), 4G, 5G, LTE FDD/TDD, etc. Furthermore, the communication system 300 may itself be connected to a host computer (see FIG. 20 for example). The network 300 (with the wireless devices 310 and network nodes 320) may be able to operate in LAA or unlicensed spectrum.

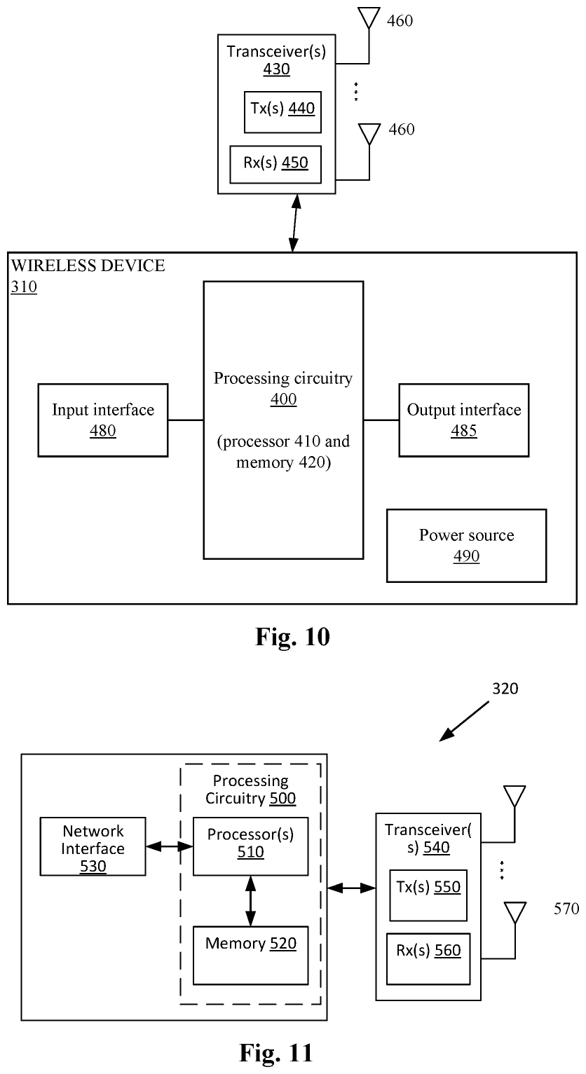

FIG. 10 is a schematic block diagram of the wireless device 310 according to some embodiments of the present disclosure. As illustrated, the wireless device 310 includes circuitry 400 comprising one or more processors 410 (e.g., Central Processing Units (CPUs), Application Specific Integrated Circuits (ASICs), Field Programmable Gate Arrays (FPGAs), and/or the like) and memory 420. The wireless device 310 also includes one or more transceivers 430 each including one or more transmitters 440 and one or more receivers 450 coupled to one or more antennas 460. Furthermore, the processing circuitry 400 may be connected to an input interface 480 and an output interface 485. The input interface 480 and the output interface 485 may be referred to as communication interfaces. The wireless device 310 may further comprise power source 490.

In some embodiments, the functionality of the wireless device 310 described above may be fully or partially implemented in software that is, e.g., stored in the memory 420 and executed by the processor(s) 410. For example, the processor 410 is configured to perform all the functionalities performed by the wireless device 310. For example, the processor 410 can be configured to perform any steps of the method 100 of FIG. 7.

In some embodiments, a computer program including instructions which, when executed by the at least one processor 410, causes the at least one processor 410 to carry out the functionality of the wireless device 310 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of a network node 320 according to some embodiments of the present disclosure. As illustrated, the network node 320 includes a processing circuitry 500 comprising one or more processors 510 (e.g., CPUs, ASICs, FPGAs, and/or the like) and memory 520. The network node also comprises a network interface 530. The network node 320 also includes one or more transceivers 540 that each include one or more transmitters 550 and one or more receivers 560 coupled to one or more antennas 570. In some embodiments, the functionality of the network node 320 described above may be fully or partially implemented in software that is, e.g., stored in the memory 520 and executed by the processor(s) 510. For example, the processor 510 can be configured to perform any steps of the method 200 of FIG. 8.

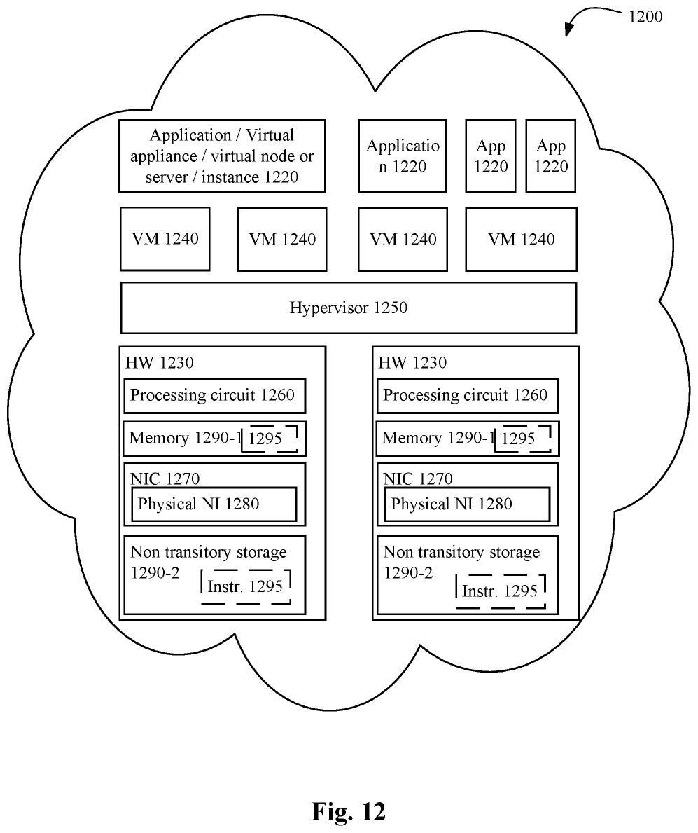

FIG. 12 is a schematic block diagram that illustrates a virtualized embodiment of the wireless device 310 or network node 320, according to some embodiments of the present disclosure. As used herein, a “virtualized” node 1200 is a network node 320 or wireless device 310 in which at least a portion of the functionality of the network node 320 or wireless device 310 is implemented as a virtual component (e.g., via a virtual machine(s) executing on a physical processing node(s) in a network(s)). For example, in FIG. 12, there is provided an instance or a virtual appliance 1220 implementing the methods or parts of the methods of some embodiments. The one or more instance(s) runs in a cloud computing environment 1200. The cloud computing environment provides processing circuits 1230 and memory 1290-1 for the one or more instance(s) or virtual applications 1220. The memory 1290-1 contains instructions 1295 executable by the processing circuit 1260 whereby the instance 1220 is operative to execute the methods or part of the methods described herein in relation to some embodiments.

The cloud computing environment 1200 comprises one or more general-purpose network devices including hardware 1230 comprising a set of one or more processor(s) or processing circuits 1260, which may be commercial off-the-shelf (COTS) processors, dedicated Application Specific Integrated Circuits (ASICs), or any other type of processing circuit including digital or analog hardware components or special purpose processors, and network interface controller(s) (NICs) 1270, also known as network interface cards, which include physical Network Interface 1280. The general-purpose network device also includes non-transitory machine readable storage media 1290-2 having stored therein software and/or instructions 1295 executable by the processor 1260. During operation, the processor(s)/processing circuits 1260 execute the software/instructions 1295 to instantiate a hypervisor 1250, sometimes referred to as a virtual machine monitor (VMM), and one or more virtual machines 1240 that are run by the hypervisor 1250.

A virtual machine 1240 is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 1240, and that part of the hardware 1230 that executes that virtual machine 1240, be it hardware 1230 dedicated to that virtual machine 1240 and/or time slices of hardware 1230 temporally shared by that virtual machine 1240 with others of the virtual machine(s) 1240, forms a separate virtual network element(s) (VNE).

The hypervisor 1250 may present a virtual operating platform that appears like networking hardware to virtual machine 1240, and the virtual machine 1240 may be used to implement functionality such as control communication and configuration module(s) and forwarding table(s), this virtualization of the hardware is sometimes referred to as network function virtualization (NFV). Thus, NFV may be used to consolidate many network equipment types onto industry standard high volume server hardware, physical switches, and physical storage, which can be located in Data centers, and customer premise equipment (CPE). Different embodiments of the instance or virtual application 1220 may be implemented on one or more of the virtual machine(s) 1240, and the implementations may be made differently.

In some embodiments, a carrier comprising the aforementioned computer program product is provided. The carrier is one of an electronic signal, an optical signal, a radio signal, or a computer readable storage medium (e.g., a non-transitory computer readable medium such as memory).

Some embodiments may be represented as a non-transitory software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to one or more of the described embodiments. Those of ordinary skill in the art will appreciate that other instructions and operations necessary to implement the described embodiments may also be stored on the machine-readable medium. Software running from the machine-readable medium may interface with circuitry to perform the described tasks.

The above-described embodiments are intended to be examples only. Alterations, modifications and variations may be effected to the particular embodiments by those of skill in the art without departing from the scope of the description, which is defined solely by the appended claims.

1. A method in a wireless device for uplink transmissions associated with a plurality of reference signal (RS) resources that belong to a plurality of resource sets, the method comprising:
receiving downlink control information (DCI) indicating an uplink transmission, the DCI further comprising an indication of one or more RS resources from the plurality of RS resources, the one or more RS resources selected from the plurality of resource sets; and
performing the uplink transmission based on the indication of the one or more RS resources in the DCI.

2. The method of claim 1, wherein the one or more RS resources are Sounding Reference Signal (SRS) resources.

3. The method of claim 2, wherein the DCI comprises a SRS Resource Indicator (SRI) field, which indicates the one or more SRS resources and the SRS resource sets to which the indicated one or more SRS resources belong.

4. The method of claim 3, wherein the plurality of RS resources is listed according to a certain order and a plurality of codepoints of the SRI field is associated with the list of ordered RS resources.

5. The method of claim 3, wherein a most significant bit (MSB) of a codepoint indicates an identity (ID) a RS resource set and a least significant bit (LSB) of the codepoint indicates an ID of a RS resource.

6. The method of claim 3, wherein a size of the SRI field is related to a total number of RS resources in the plurality of RS resources across the plurality of resource sets.

7. The method of claim 6, wherein the size of the SRI field is determined as ┌log₂n/m┐ bits if m Transmit and n Receive (mTnR) antenna switching is configured.

8. The method of claim 2, wherein the DCI comprises two bitfields, a first bitfield for indicating a resource set and a second bitfield for indicating a RS resource within the resource set indicated by the first bitfield.

9. The method of claim 1, wherein the one or more RS resources indicated in the DCI are used for both reciprocity-based operation and codebook-based uplink transmission.

10. The method of claim 1, wherein a usage of the one or more RS resources indicated in the DCI is set to antenna switching.

11. (canceled)

12. (canceled)

13. The method of claim 3, wherein the DCI comprises two or more SRI fields, each SRI field associated with a Transmission and Reception Point (TRP), when the wireless device operates in a multi-TRP environment.

14. (canceled)

15. The method of claim 1, wherein the wireless device is configured with 1 transmit chain and 4 receive chains (1T4R).

16. The method of claim 3, wherein the SRI field indicates one SRS resource per resource set up to two resource sets from the plurality of resource sets.

17. A method in a network node for indicating uplink transmissions to a wireless device, the uplink transmissions associated with a plurality of reference signal (RS) resources that belong to a plurality of resource sets, the method comprising:
sending downlink control information (DCI) indicating an uplink transmission, the DCI further comprising an indication of one or more RS resources from the plurality of RS resources, the one or more RS resources selected from the plurality of resource sets; and
receiving the uplink transmission based on the indication of the one or more RS resources in the DCI.

18. The method of claim 17, wherein the one or more RS resources are Sounding Reference Signal (SRS) resources.

19. The method of claim 18, wherein the DCI comprises a SRS Resource Indicator (SRI) field, which indicates the one or more SRS resources and the resource sets to which the indicated one or more SRS resources belong.

20. (canceled)

21. The method of claim 19, wherein a most significant bit (MSB) of a codepoint indicates an identity (ID) a RS resource set and a least significant bit (LSB) of the codepoint indicates an ID of a RS resource.

22. The method of claim 19, wherein a size of the SRI field is related to a total number of RS resources in the plurality of RS resources across the plurality of resource sets.

23. The method of claim 22, wherein the size of the SRI field is determined as ┌log₂ n/m┐ bits if m Transmit and n Receive (mTnR) antenna switching is configured.

24. (canceled)

25. (canceled)

26. (canceled)

27. (canceled)

28. (canceled)

29. (canceled)

30. (canceled)

31. (canceled)

32. A wireless device comprising a communication interface and processing circuitry connected thereto and configured to receive downlink control information (DCI) indicating an uplink transmission, the DCI further comprising an indication of one or more RS resources from the plurality of RS resources, the one or more RS resources selected from the plurality of resource sets; and
preform the uplink transmission based on the indication of the one or more RS resources in the DCI.

33. (canceled)

34. (canceled)
